(19) United States
(12) Patent Application Publication
(10) Pub. No.: US 2015/0279216 A1
(43) Pub. Date: Oct. 1, 2015

(54) SYSTEM AND METHOD FOR A CAB DRIVER TO LOCATE A PERSON

(71) Applicant: APPROACH ME, INC, Santa Clara, CA (US)

(72) Inventor: TARIQ TONY GHANMA, Santa Clara, CA (US)

(21) Appl. No.: 14/582,825

(22) Filed: Dec. 24, 2014

Related U.S. Application Data
(60) Provisional application No. 61/970,847, filed on Mar. 26, 2014.

(51) Int. Cl. G08G 1/00; G06Q 10/06; G06Q 50/30; H04W 4/02

(52) U.S. Cl. CPC G08G 1/202; H04W 4/023; G06Q 10/063114; G06Q 50/30

(57) ABSTRACT

A computer-implemented method for locating a person is disclosed. The method comprises (a) receiving a request for a cab from a user via a mobile device of the user; (b) assigning pick up of the user to a cab driver; (c) tracking the distance and bearing of the user and the cab driver relative to each other; (d) transmitting the distance and bearing of the cab driver relative to the user to the mobile device of the user; wherein said transmitting is via a network; (e) transmitting the distance and bearing of the user relative to the cab driver to the mobile device of the cab driver; wherein said transmitting is via a network.

The present application claims the benefit of priority to U.S. Provisional Patent Application No. 61/970,847, filed Mar. 26, 2014, the disclosure of which is hereby incorporated by reference.

### FIELD

Embodiments of the present invention relate to systems and methods for locating people.

### BACKGROUND

There are many scenarios where it is difficult to locate a person for a meeting or rendezvous. Examples of such scenarios include meeting at a crowded location such as at a shopping mall, sports event, convention, a cab driver trying to locate a person in a crowded location, etc.

### SUMMARY

According to a first aspect of the invention, there is provided a method for locating a first person by at least one second person. In accordance with the method, each of the first and second persons have an electronic device equipped with at least a location sensor and a magnetic sensor.

The electronic devices may be in the form of a smartphone provisioned with a client software component in the form of an app called the “Approach Me Client (AMC)”. The AMC client may be configured to read location and magnetic data generated by the location and magnetic sensors, respectively. The location data may be in the form of a latitude and longitude, whereas the magnetic data may be in the form of a compass direction.

Typically, the first person initiates a request for a rendezvous, the purpose of which can vary. For example, the purpose may be a social gathering at an event, say a sports event, or to facilitate pick up by a cab driver. For descriptive convenience, the first person is assumed to initiate the request for the rendezvous and will be referred to herein as the initiator. All second persons responding to the request will be referred to herein a respondents.

For the initiator a set of calculations is performed. These calculations include calculating a distance from the initiator to each respondent and the direction of each respondent relative to the initiator. A user-interface (UI) may be invoked on the electronic device of the initiator wherein the position of the initiator is plotted at a center of the UI with the position of each respondent is shown relative to the initiator. The UI is advantageously “radar-like” in appearance with concentric distance rings centered on the position of the initiator. Each distance ring represents a certain fixed distance from the initiator's location, which as noted above is plotted at the center of the UI. The UI also shows the direction of each respondent relative to the initiator. A portion of the UI also functions as a compass.

As the relative distance and bearing between the initiator and each of the respondents changes, that is updated to reflect said changes in the distance and bearing the each respondent relative to the initiator.

For each respondent a similar UI may be provided. This time the position of the respondent is plotted at the center of the UI with the distance and bearing of each other respondent participating in the rendezvous

Other aspects of the invention will be apparent from the detailed description below.

### BRIEF DESCRIPTION OF THE FIGURES

FIG. 1 shows a network configuration 100 for practicing embodiments of the present invention.

FIG. 2. shows a process for creating the meeting, in accordance with one embodiment of the invention.

FIG. 3 shows a process by the AMS to create a meeting, in accordance with one embodiment.

FIG. 4 shows a process by the AMC to process a meeting request, in accordance with one embodiment of the invention.

FIG. 5 shows a process by the AMS for location and bearing tracking, in accordance with one embodiment.

FIG. 6 shows a process by the AMC for location and bearing tracking during a meeting, in accordance with one embodiment of the invention.

FIG. 7 shows the radar user interface (UI) of the present invention, in accordance with one embodiment.

FIGS. 8-9 show a user interface for a cab driver, in accordance with one embodiment.

FIG. 10 shows an example of hardware 1000 that may be used to implement the server device 104 in accordance with one embodiment.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block or flow diagram form only in order to avoid obscuring the invention. Accommodate

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to the details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

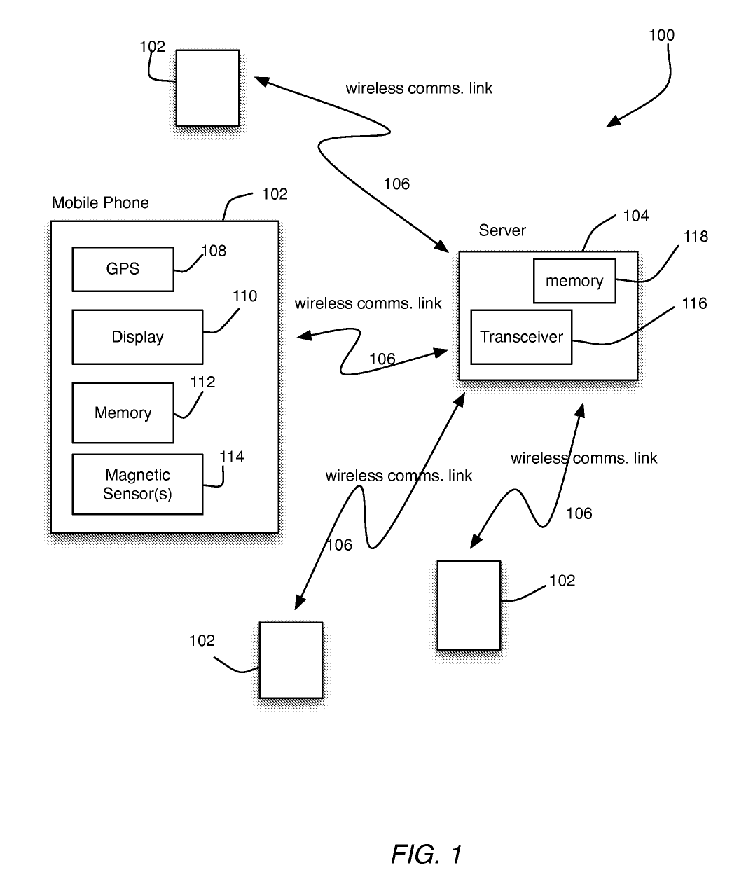

FIG. 1 shows a network configuration 100 for practicing embodiments of the present invention. As will be seen, a plurality of mobile devices 102 in the form of mobile phones are able to connect with a server device 104 via wireless communications links 106.

Components of each mobile phone 102 comprise:
1. GPS module 108. The GPS module 108 may comprise GPS sensors, and associated software and hardware circuitry to provide GPS functionality to the mobile phone 102;
2. Display 110 for outputting information to a user. Preferably, the display 110 supports touch-based inputs;
3. Memory 112 comprising software including an operating system, and typically various other apps. Of interest here is an app called the “Approach Me Client (AMC)” to facilitate locating of people, as will be described.
4. Magnetic Sensor(s) 114 and associated software and hardware circuitry to provide sensing of the earth's magnetic pole to enable bearing information (“directional compass data”) as is described in US 20140062469, which is incorporated herein by reference.

Wireless communications links 106 may support any wireless protocol such as GMS and CDMA to enable cellular communications.

Server device 104 comprises a transceiver 116 and a memory 118. The transceiver 116 enables the sending and receiving of communications, whereas the memory 118 stores instructions to enable the server device to operate and provide various functions. Of interest here in that the server device 104 comprises software call the “Approach Me Server (AMS)” configured to cooperate with the AMC to facilitate the location of people, as will be described.

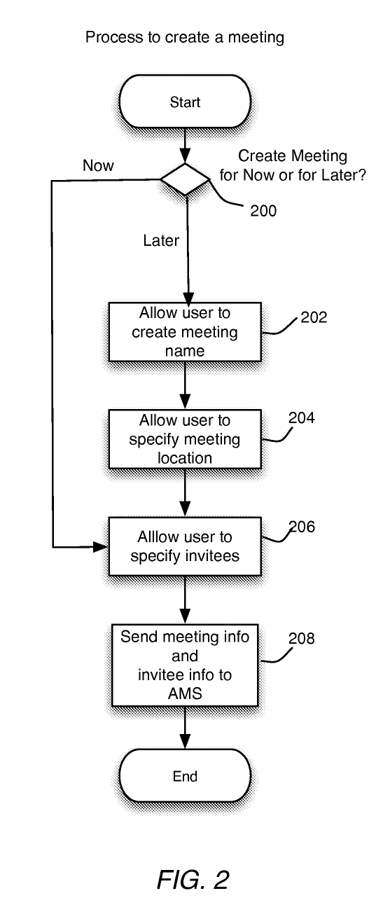

The AMC may be used to facilitate a method for locating a first person by at least one second person, as will now be described. The first person is the person who initiates a request for a rendezvous. For ease reference, the first person will be referred to herein as “the Initiator”. To begin, the Initiator may be at a particular location, say at a shopping mall or at a rock concert. Using the AMC, the Initiator creates a meeting/rendezvous. The process for creating the meeting, in accordance with one embodiment, is illustrated in the flowchart of FIG. 2.

Referring to FIG. 2, at block 200, control branches based on whether the user wants to create a meeting for the present moment (now) as opposed to for later. For example, the user may be given the option of creating a meeting for now or for later. If the meeting is to be created for now, them control passes to block 208, otherwise control passes to block 202.

At block 202, the user is allowed to enter a name for the meeting. This may be an optional step. At block 204, the user is allowed to specify a location for the meeting. The location may be, for example, at a location where there is going to be a large crowd such at a convention, tradeshow, concert, sports event, etc.

At block 206, the user is allowed to specify the invitees to the meeting. For example, the AMC may access a contact list stored on the mobile phone of the user to allow the user to select the contacts as invitees. Alternatively, the user may be allowed to specify an invitee by phone number or by email address. At block 208, meeting information and the invitee information is sent to the AMS via the wireless communications link 106. The meeting information may include the meeting name, the meeting location, the meeting time, and a meeting id.

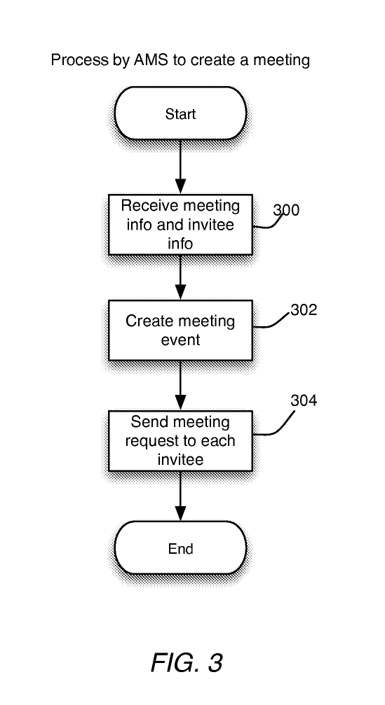

FIG. 3 shows a process by the AMS to create a meeting, in accordance with one embodiment. Referring to FIG. 3, at block 300 the meeting information and the invitee information that was transmitted as per block 208 is received. Responsive to receiving the meeting and invitee information, at block 302, a meeting is creating based on the meeting id. The meeting is given attributes of name, time, location, and invitees. At block 304, a meeting request is sent to each invitee. In particular, each invitee receives a meeting request on his/her mobile device via the AMC.

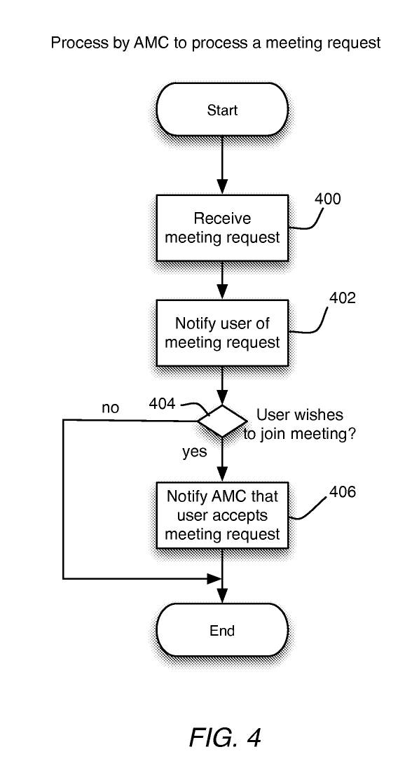

FIG. 4 shows a process by the AMC to process a meeting request, in accordance with one embodiment of the invention. Referring to FIG. 4, at block 400 the meeting request is received by the AMC. This is the meeting request that was sent by the AMS at the previously described block 304.

At block 402, the AMC notifies the user of the meeting request. At block 404, the AMC determines if the user wishes to join the meeting. For the user may be provided with an option to join the meeting. If the user selects the option to join the meeting then control passes to block 406, otherwise the process ends. At block 406, the AMC send a transmission to the AMS to notify the AMS that the user as accepted the meeting invitation. Such a user, i.e. one who wishes to join a meeting will be referred to herein a “respondent”. Moreover, the term “meeting participant” shall refer to all respondents plus the initiator of the meeting.

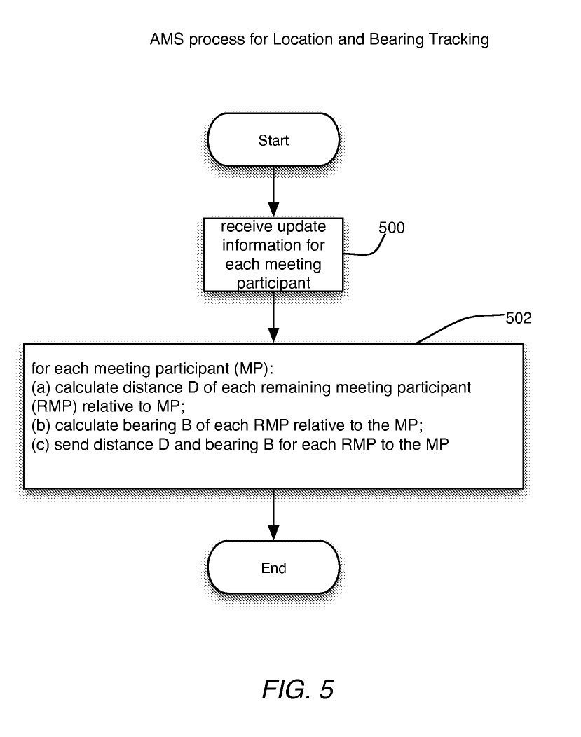

FIG. 5 shows a process by the AMS for location and bearing tracking, in accordance with one embodiment. Referring to FIG. 5, at block 500, the AMS receives update information for each meeting participant (MP). The update information includes the latest location and bearing information for each meeting participant (MP). At block 502, the AMS performs the following steps of each meeting participant (MP):

(a) calculate the distance D of each remaining meeting participant (RMP) relative to the meeting participant (MP);

(b) calculate the bearing B of each remaining meeting participant (RMP) relative to the meeting participant (MP); and

(c) send the distance D and the bearing B calculated for each remaining meeting participant (RMP) to the meeting participant (MP).

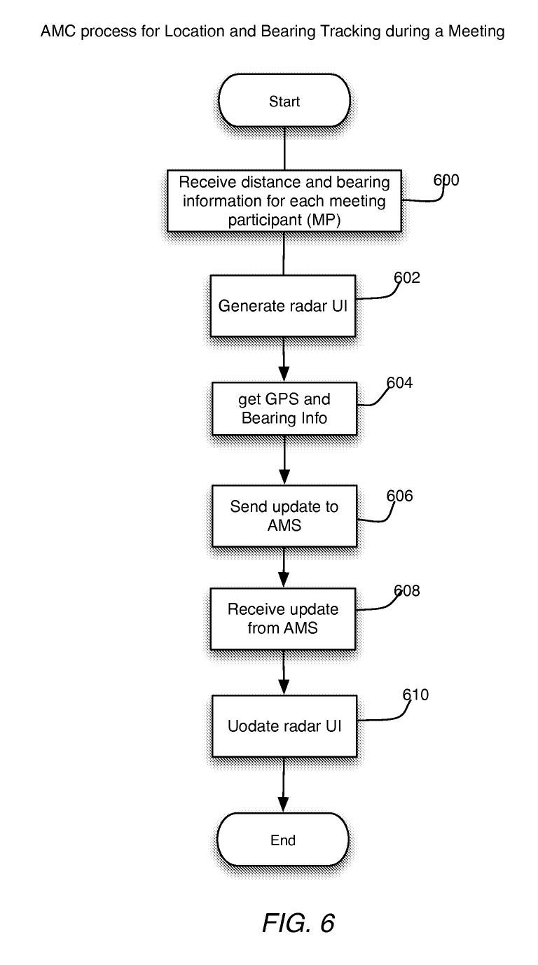

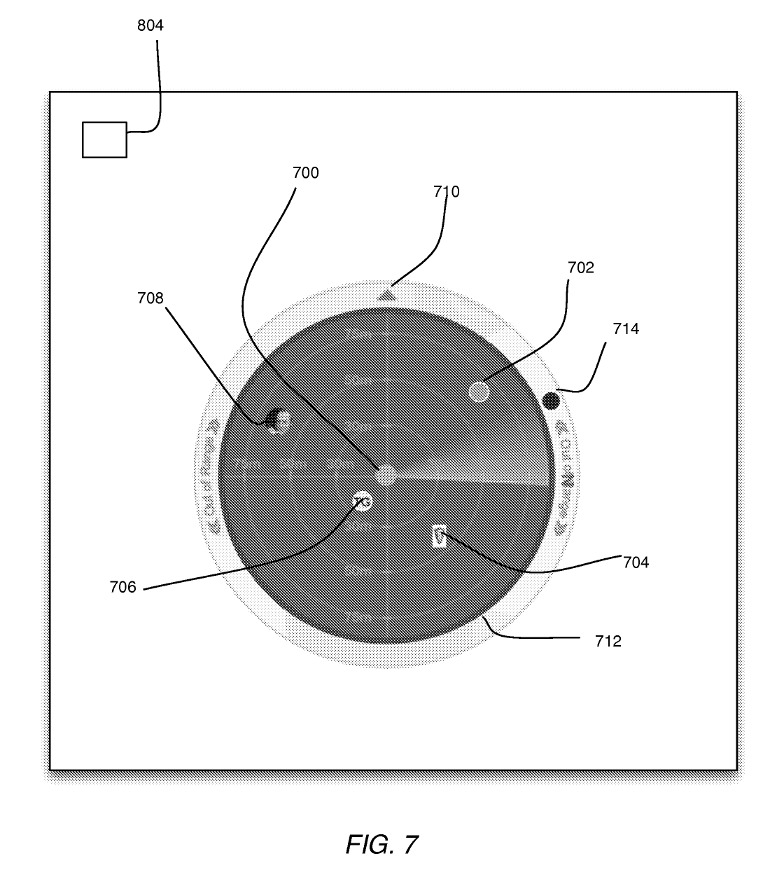

FIG. 6 shows a process by the AMC for location and bearing tracking during a meeting, in accordance with one embodiment of the invention. The process is performed for each meeting participant (MP). Referring to FIG. 6, at block 600, distance and bearing information for each remaining meeting participant (RMP) is received. This is the same information that was calculated under the block 502, which was described above. At block 602, a user interface (UI) is generated to show the location of all meeting participants. Advantageously, the user interface (UI) is “radar-like” in appearance. An exemplary user interface (UI) is shown in FIG. 7 of the drawings, in accordance with one embodiment. It is noted that for the user interface (UI), the meeting participant (MP) is plotted at the center, and the position of each remaining meeting participant (RMP) is plotted relative to the meeting participant (MP) at the center as a function of distance and bearing relative to said meeting participant (MP).

At block 604, the AMC gets GPS and bearing information (compass data) for the meeting participant (MP). This is done by accessing GPS and compass data associated with the mobile phone on which the AMC is running The block 604 is repeated at periodic intervals during a meeting. The intervals may be determined in order to provide real-time updates on location and bearing for each meeting participant. At block 606, the AMC sends and update to the AMS. The update comprises the GPS and bearing formation determined under the block 604.

Periodically, at block 608 the AMS receives an update from the AMS. This update comprise the latest location and bearing information for each remaining meeting participant (RMP) relative to the meeting participant (MP). The information in the update is computed under the block 502 of FIG. 5. Based on the update, the AMC update the radar UI at block 610.

FIG. 7 shows the radar user interface (UI) of the present invention, in accordance with one embodiment. The radar UI is drawn for each meeting participant (MP) showing the meeting participant at the center of the UI. In this case, the meeting participant (MP) is indicated by the orange dot 700. All remaining meeting participants (RMP) are shown around the meeting (MP) based on distance and bearing relative to the meeting participant (MP). In the example of FIG. 7, there are 4 remaining meeting participants (RMP) indicated by reference numerals 702 to 708. It is noted that each remaining meeting participant (RMP) is indicated by a different indicator. According to different embodiments, the indicators may comprise circle of different colors, circles with the initials of the meeting participant (MP) bounded within the circles, to circles with a photo image of the meeting participant within the circles, etc.

Distances on the radar UI may be indicated by concentric circles around the center of the UI, each circle representing a particular distance from the center, e.g. 30 m, 50 m, 75 m, etc. The distances may be indicated in feet or meters based on user preference.

The radar UI also comprises an indicator 710 representing the compass direction North. In one embodiment, an outer band 712 represents a compass ring. The compass ring indicates a bearing in the range 0 to 360 degrees, with the 0 and 360 degree position corresponding to the North direction. Within this ring, an indicator 714 represents a remaining meeting participant (RMP) who is out-of-range, e.g. the remaining meeting participant (RMP) may be 500 m away. For this user only the direction/bearing relative to the meeting participant (MP) for whom the radar UI is generated is shown.

Based on the foregoing, in one aspect, the present invention may be framed as a computer-implemented method for locating a person. The method may comprises the following steps: (a) from a mobile phone of an initiator I, generating a request for a rendezvous;

(b) sending said request to a mobile phone of at least one respondent R;

(c) for each respondent R that accepts the request:
(1) calculating a distance D of the respondent R relative to the initiator I; and
(2) calculating the bearing B of the respondent R relative to the initiator I; and

(d) transmitting to the mobile phone of the initiator I, the distance D and bearing B calculated for respondent R; wherein said transmitting is vis a network. Other aspects of this method are described below.

The method may comprise plotting the position of each respondent R on a user interface for the mobile phone of the initiator I as a function of distance D and bearing B relative to the position of initiator I, which is indicated at a center of said user interface.

The method may comprise, for each respondent Rᵢ, plotting the positon of said respondent Rᵢ at the center of a user interface for the mobile phone of said respondent Rᵢ; and plotting the position of initiator I and every other respondent Rj on said user interface as a function of distance D and bearing B relative to the position of initiator Rᵢ.

The method may comprise, the step (c) performed by a server communicatively coupled to the mobile phone.

The method may comprise, the step (c)(1) performed based on the Haversine formula.

The method may comprise, a portion of said user interface being used as a compass.

The method may comprise the step (c)(1) performed periodically and updates in positon and bearing of the initiator I and each respondent R are sent to phones of the initiator I and each respondent R.

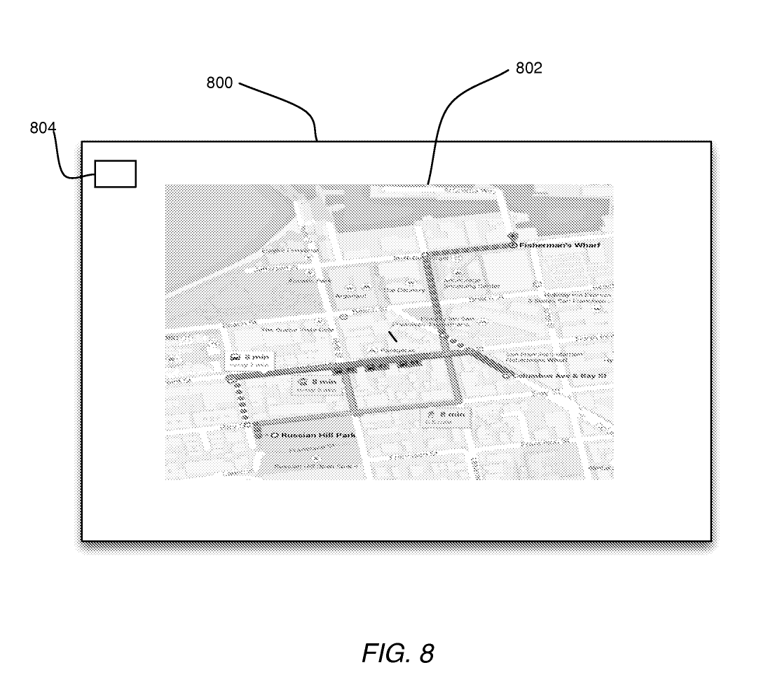

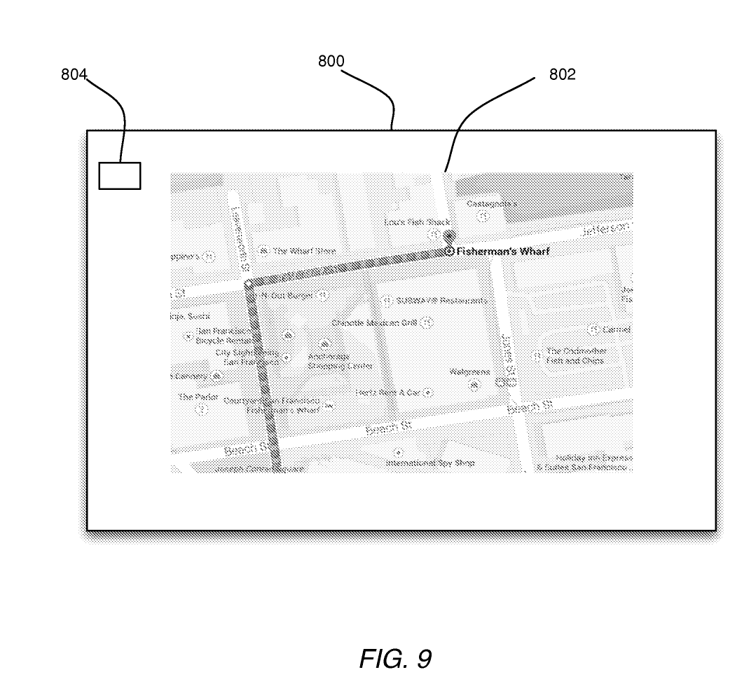

The technology described herein may be adapted to help taxi drivers locate passengers who have requested a ride using their mobile phone. Companies such as Uber and Lyft provide services whereby a user can request to be picked up at a location indicated by the GPS location associated with their mobile phone. Such services may be improved using the technology disclosed herein as will now be described. Suppose a user has requested a ride via Uber and that the users' location is at the Fisherman's Wharf in San Francisco, Calif. Suppose further that a cab driver who is currently somewhere near Russian Hill Park, San Francisco, Calif. is assigned the task of picking up the user. Also assume that the cab driver is using a GPS-enabled device (e.g. a smartphone) to navigate to the user. Typically, the GPS-enabled device will show the cab driver a UI 800 with a map such as the map 802 shown in FIG. 8 As the cab driver approaches gets closer to the user, the scale of map 802 will change to show more detail of the area surrounding the user's location. This is indicated in FIG. 9 where the map 802 is updated to show more detail around the Fisherman's Wharf. However, the Fisherman's Wharf may be crowed making it difficult for the cab driver to find the user.

Therefore, in one embodiment both the GPS-enabled device of the cab driver and the mobile phone of the user are provisioned with the AMC disclosed herein. The action of the user requesting a ride is treated as a meeting request and the cab driver who is assigned to pick up the user is treaded as a respondent. The AMC tracks the location of both the cab driver and user in accordance with the techniques disclosed herein. Regular updates are sent to the devices of both meeting participants.

In one embodiment the UI shown in FIGS. 8 and 9 is modified to include a map-to-radar toggle button 804. The cab driver can use this button to toggle the UI to from the map view shown to a radar view in which a radar UI similar to that of FIG. 7 is displayed. Referring to FIG. 7, the cab driver can once again use the button 804 toggle from radar view back to map view. Likewise, the user who is waiting for the cab can uses the button 804 to toggle between map view and radar view. For example, if it is raining, the user can wait indoors and track the location of the cab driver using the map view. When the cab driver is getting close, the user can toggle to radar view to locate the cab.

Advantageously, in radar view the location and bearing of the user is plotted relative to the cab driver whose position is indicated at the center of the radar UI. The user may also locate the cab driver using a radar view that plots the location and bearing of the cab driver relative to the user whose position is indicated at the center of the radar UI.

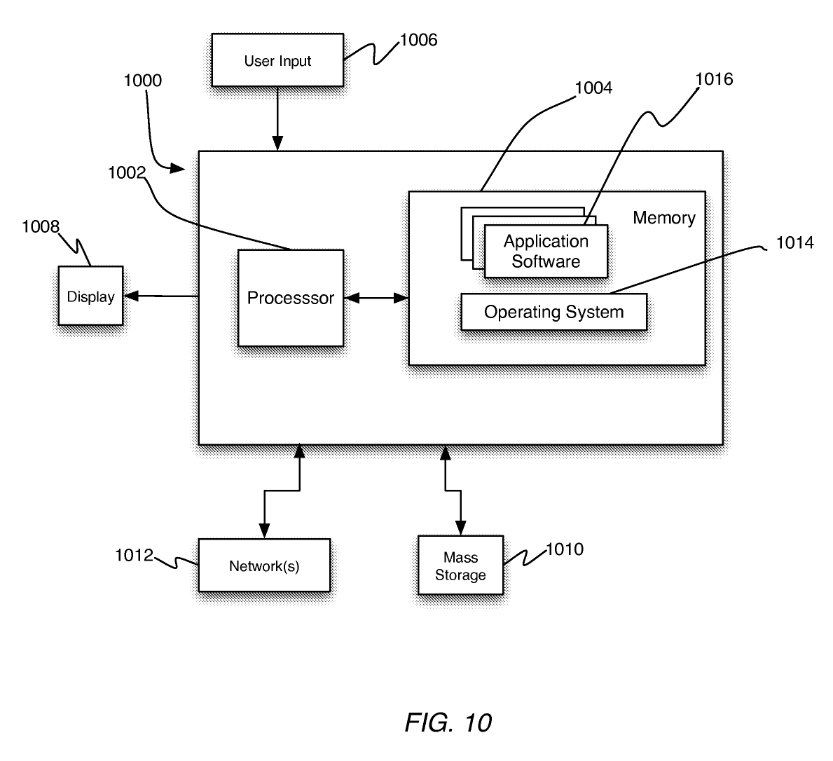

FIG. 10 shows an example of hardware 1000 that may be used to implement the server device 104 in accordance with one embodiment. The hardware 1000 may includes at least one processor 1002 coupled to a memory 1004. The processor 1002 may represent one or more processors (e.g., microprocessors), and the memory 1004 may represent random access memory (RAM) devices comprising a main storage of the hardware, as well as any supplemental levels of memory e.g., cache memories, non-volatile or back-up memories (e.g. programmable or flash memories), read-only memories, etc. In addition, the memory 1004 may be considered to include memory storage physically located elsewhere in the hardware, e.g. any cache memory in the processor 81002, as well as any storage capacity used as a virtual memory, e.g., as stored on a mass storage device.

The hardware also typically receives a number of inputs and outputs for communicating information externally. For interface with a user or operator, the hardware may include one or more user input output devices 1006 (e.g., a keyboard, mouse, etc.) and a display 1008. For additional storage, the hardware 1000 may also include one or more mass storage devices 1010, e.g., a Universal Serial Bus (USB) or other removable disk drive, a hard disk drive, a Direct Access Storage Device (DASD), an optical drive (e.g. a Compact Disk (CD) drive, a Digital Versatile Disk (DVD) drive, etc.) and/or a USB drive, among others. Furthermore, the hardware may include an interface with one or more networks 1012 (e.g., a local area network (LAN), a wide area network (WAN), a wireless network, and/or the Internet among others) to permit the communication of information with other computers coupled to the networks. It should be appreciated that the hardware typically includes suitable analog and/or digital interfaces between the processor 1002 and each of the components, as is well known in the art.

The hardware 1000 operates under the control of an operating system 1014, and executes application software 1016 which includes various computer software applications, components, programs, objects, modules, etc. to perform the techniques described above.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), flash drives among others.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

1. A computer-implemented method for locating a person, comprising:
(a) receiving a request for a cab from a user via a mobile device of the user;
(b) assigning pick up of the user to a cab driver;
(c) tracking the distance and bearing of the user and the cab driver relative to each other;
(d) transmitting the distance and bearing of the cab driver relative to the user to the mobile device of the user; wherein said transmitting is via a network;
(e) transmitting the distance and bearing of the user relative to the cab driver to the mobile device of the cab driver; wherein said transmitting is via a network.

2. The method of claim 1, further comprising plotting the position of the cab driver on a radar user interface for the mobile phone of the user as a function of distance D and bearing B relative to the position of user, which is indicated at a center of said user interface.

3. The method of claim 2, further comprising plotting the position of the user on a radar user interface for the mobile device of the cab driver as a function of distance D and bearing B relative to the position of cab driver, which is indicated at a center of said user interface.

4. The method of claim 3, wherein the user interface of the cab driver has a first mode with displays a map to the user.

5. The method of claim 3, wherein the user interface of the cab driver has a second mode with displays the radar user interface.

6. The method of claim 6, allowing the cab driver to toggle the user interface to selectively show one of the map view and the radar user interface.

7. A non-transitory computer-readable medium having stored thereon, a sequence of instructions which when executed by a system, causes the system to perform a method comprising:
(a) receiving a request for a cab from a user via a mobile device of the user;
(b) assigning pick up of the user to a cab driver;
(c) tracking the distance and bearing of the user and the cab driver relative to each other;
(d) transmitting the distance and bearing of the cab driver relative to the user to the mobile device of the user; wherein said transmitting is via a network;
(e) transmitting the distance and bearing of the user relative to the cab driver to the mobile device of the cab driver; wherein said transmitting is via a network.

8. The computer-readable medium of claim 8, wherein the method further comprises plotting the position of the cab driver on a radar user interface for the mobile phone of the user as a function of distance D and bearing B relative to the position of user, which is indicated at a center of said user interface.

9. The computer-readable medium of claim 9, wherein the method further comprises plotting the position of the user on a radar user interface for the mobile device of the cab driver as a function of distance D and bearing B relative to the position of cab driver, which is indicated at a center of said user interface.

10. The computer-readable medium of claim 9, wherein the user interface of the cab driver has a first mode with displays a map to the user.

11. The computer-readable medium of claim 9, wherein the user interface of the cab driver has a second mode with displays the radar user interface.

12. The computer-readable medium of claim 10, further comprising allowing the cab driver to toggle the user interface to selectively show one of the map view and the radar user interface.
